(19) United States
(12) Patent Application Publication
(10) Pub. No.: US 2013/0067329 A1
(43) Pub. Date: Mar. 14, 2013

(54) IMPLICIT MEDIA SELECTION

(71) Applicants: Prashant Patali, Issaquah, WA (US); Madhuvan Gupta, Redmond, WA (US); Joe Chauvin, Sammamish, WA (US); Zane Salim, Seattle, WA (US); Matthieu Maitre, Redmond, WA (US); Jason Roberts, Bellevue, WA (US); Ramees Khan Rahumathulla, Redmond, WA (US)

(72) Inventors: Prashant Patali, Issaquah, WA (US); Madhuvan Gupta, Redmond, WA (US); Joe Chauvin, Sammamish, WA (US); Zane Salim, Seattle, WA (US); Matthieu Maitre, Redmond, WA (US); Jason Roberts, Bellevue, WA (US); Ramees Khan Rahumathulla, Redmond, WA (US)

(73) Assignee: Microsoft Corporation, Redmond, WA (US)

(21) Appl. No.: 13/229,723

(22) Filed: Sep. 11, 2011

(51) Int. Cl. G06F 3/048

(52) U.S. Cl. 715/716

(57) ABSTRACT

In one embodiment, a media device 102 may share a selected media element 108 based on minimal user input. A user input 260 may receive a generic action input 110 from a user. A processor 220 may execute an implicit media selection of a selected media element 108 from a multimedia layout 106 having multiple media element candidates displayed by a source media display application 104.

### BACKGROUND

Most modern software applications, particularly web applications, rarely display one type of media. A web page may show text, digital images, audio, video, and other forms of media. While the web page may display many different types of media, a user may choose to focus on one media element out of the many.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to a media device sharing a selected media element based on minimal user input. A user input may receive a generic action input from a user. A processor may execute an implicit media selection of a selected media element from a multimedia layout having multiple media element candidates displayed by a source media display application.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a local network of media display platforms.

FIG. 2 illustrates, in a block diagram, one embodiment of a computing device.

FIG. 3 illustrates, in a block diagram, one embodiment of a multimedia layout.

FIG. 4 illustrates, in a flowchart, one embodiment of a method for activating a selected media element.

FIG. 5 illustrates, in a flowchart, one embodiment of a method for executing an implicit media selection.

FIG. 6 illustrates, in a flowchart, one embodiment of a method for executing an implicit platform selection.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a media device.

A media device may present multiple media elements at the same time, such as video, music, digital image, and text items. The media device may concurrently present the multiple media elements through the use of multiple media display applications or by aggregating the multiple media elements into a multimedia layout. The media display application may be a web page, a search result showing a mosaic of media in response to a web query, or a custom application with multiple media elements. A user may want to perform an action with the media element, such as sharing the media element with a social networking site, printing the media element, playing the media element locally, or streaming the media element to a different media device. Sometimes, these actions may be in response to a generic action input, such as a hardware play button on the media device or a software “button” that enables media content to play or stream. The generic action input is an indication for a media element to perform an action, such as playing or sharing with a target media display platform. The generic action input is a not an explicit media selection tool.

If no media element is selected and the user hits play, the play behavior may be indeterminate. In some applications, the video may not play since none is selected. However, a media device may execute an implicit media selection to guess the likely intent of the user, without an explicit input from the user. The media device may play the appropriate media element even if none is selected. Developers of the media display application or media layout may provide hints. The developers may also disable the ability to play or stream from a specific media element.

The media selection criteria may vary depending on the media context. For example, the presence of a hardware play button may suggest identifying a video before other types of media, such as images. However, the presence of a print or share button may suggest selecting a photo for printing. In addition, the media device may select images over a certain size to prevent printing icons and other bitmaps.

Many media display applications may give greater weight to a user preference over a developer preference. Therefore, weighting the intent of a user may take priority over the intent of a developer. A developer may recommend a media element by embedding a developer hint, identifying a media element to be used unless overridden by an explicit selection by the user. Alternately, the developer may give primacy to a media element by embedding a developer directive or disable a media element from selection by embedding a disabling flag.

The media device may determine the user intent based on a media state. The media state describes the level of interaction between a user and a media element. For example, if a media element has been given focus by user selection or playing, the media device may interpret that action as an explicit selection, prioritizing that media element over other media elements. If multiple media elements or no media elements are selected, the media device may apply other criteria. For example, if a single media element has been manually selected by the user, then the media device may stream that media element. If no media element is selected, the media device may select from the media elements that are currently visible to the user. Otherwise, the media device may select media elements currently playing. Else, the media device may select media elements the developer has marked as primary. The media device may use each of these criteria to narrow to a single media element.

If the selection logic produces multiple results, the media device may apply further criteria. For example, if multiple media elements are currently playing, but a single media element is visible, the media device may select the media element. Similarly, if multiple media elements are visible, the media device may select the media element with an embedded developer hint. If the media device still is unable to narrow the multiple media elements to a single media element, the media display application may present a user interface allowing the user to select from the final media elements in the list. Alternatively, the media device may present an error message to the user requesting further narrowing actions.

Thus, in one embodiment, a media device may share a selected media element based on minimal user input. A user input may receive a generic action input from a user. A processor may execute an implicit media selection of a selected media element from a multimedia layout having multiple media element candidates displayed by a source media display application.

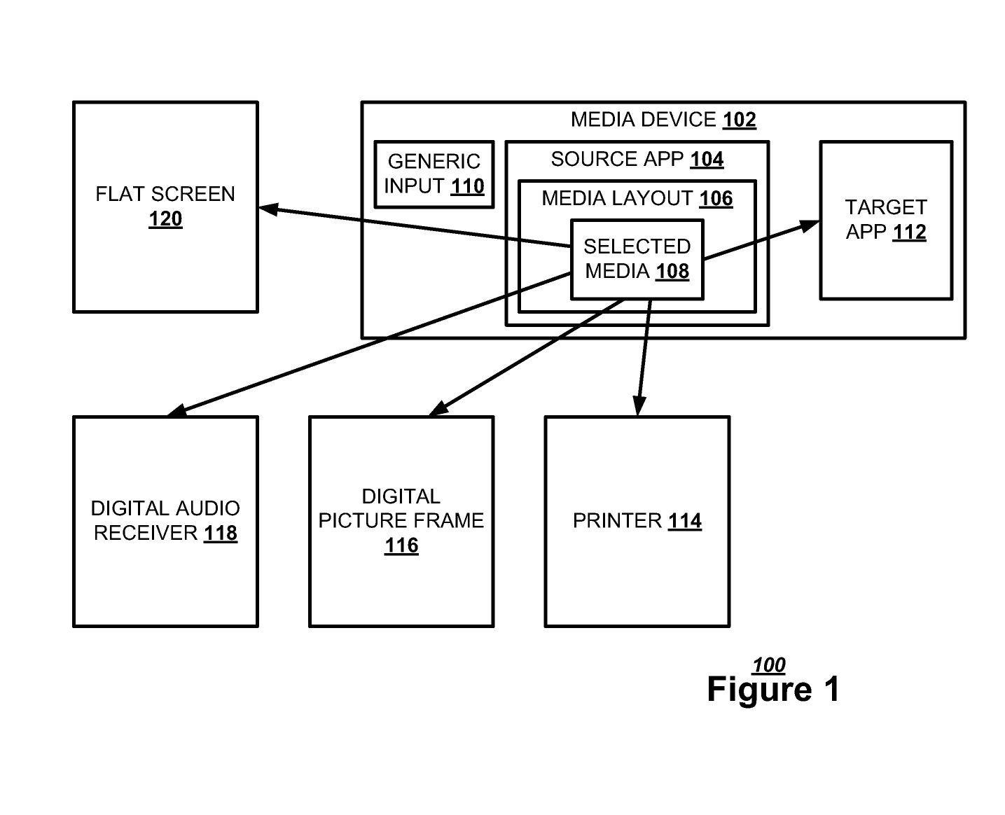

FIG. 1 illustrates, in a block diagram, one embodiment of a local network 100 of media display platforms. A media device 102 may execute a source media display application 104 displaying a media layout 106 having multiple media element candidates. The media device 102 may select one of the media element candidates to be a selected media element 108 to be played on or shared with a media display platform upon receiving a generic action input 110 from a user. The generic action input 110 may be a virtual button on a touch screen or a hardware button on the device. If the source media display application 104 is the only media display platform present, then the selected media element 108 may be selected or played on the source media display application. If other media display platforms are present, then source media display application may share the selected media element 108 with a target media display platform. The target media display platform may be a separate target media display application 112 executed on the same media device 102. Thus, the target media display application 112 may display a selected media element 108. For example, a video posted in a web-log, or “blog”, may be moved to a social network page. The target media display application 112 may be identified by being active.

Alternately, the target media display platform may be a separate target media display device. A target media display device is any digital device capable of receiving a media data file for presentation to a user. The target media display device may receive the media data file over a wired or wireless medium. For example, the source media display application 104 may send a text element or a digital image to a printer 114 for printing. The source media display application 104 may send a digital image to a digital picture frame 116 for displaying. The source media display application 104 may send an audio element to a digital audio receiver 118 for playing. The source media display application 104 may send a video element to a flat screen television 120 for playing.

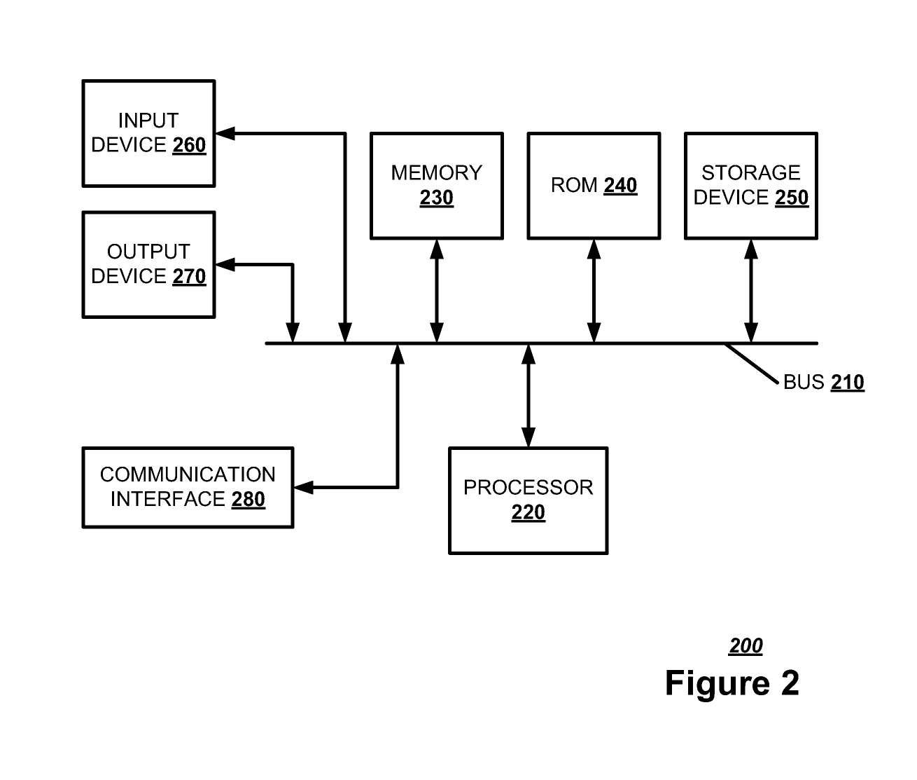

FIG. 2 illustrates a block diagram of an exemplary computing device 200 which may act as a media device. The computing device 200 may combine one or more of hardware, software, firmware, and system-on-a-chip technology to implement a media display application. The computing device 200 may include a bus 210, a processor 220, a memory 230, a read only memory (ROM) 240, a storage device 250, an input device 260, an output device 270, and a communication interface 280. The bus 210 may permit communication among the components of the computing device 200.

The processor 220 may include at least one conventional processor or microprocessor that interprets and executes a set of instructions. The memory 230 may be a random access memory (RAM) or another type of dynamic storage device that stores information and instructions for execution by the processor 220. The memory 230 may also store temporary variables or other intermediate information used during execution of instructions by the processor 220. The ROM 240 may include a conventional ROM device or another type of static storage device that stores static information and instructions for the processor 220. The storage device 250 may include any type of tangible machine-readable medium, such as, for example, magnetic or optical recording media and its corresponding drive. The storage device 250 may store a set of instructions detailing a method that when executed by one or more processors cause the one or more processors to perform the method. The storage device 250 may also be a database or a database interface for storing a media element candidate.

The input device 260 may include one or more conventional mechanisms that permit a user to input information to the computing device 200, such as a keyboard, a mouse, a voice recognition device, a microphone, a headset, etc. The output device 270 may include one or more conventional mechanisms that output information to the user, including a touch screen, a display, a printer, one or more speakers, a headset, or a medium, such as a memory, or a magnetic or optical disk and a corresponding disk drive. The communication interface 280 may include any transceiver-like mechanism that enables computing device 200 to communicate with other devices or networks. The communication interface 280 may include a network interface or a mobile transceiver interface. The communication interface 280 may be a wireless, wired, or optical interface. In one embodiment, the communication interface 280 may include a universal serial bus (USB) interface, a Bluetooth® interface, or other such interface that may be used to attach peripheral devices or pair other devices.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the storage device 250, or from a separate device via the communication interface 280.

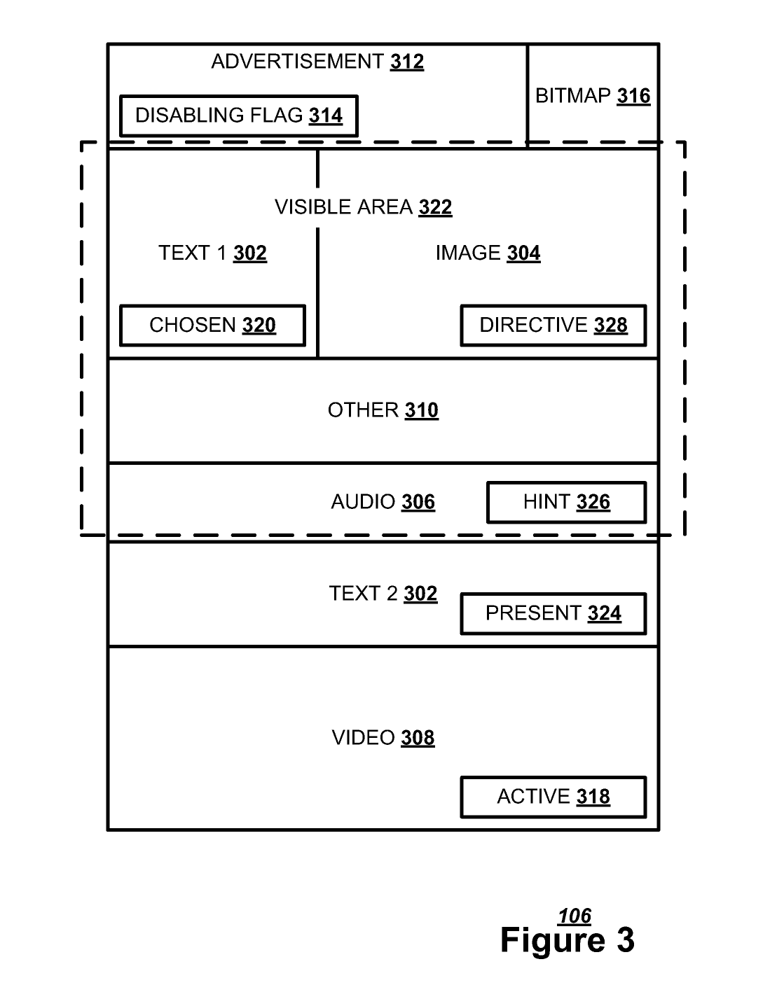

FIG. 3 illustrates, in a block diagram, one embodiment of a multimedia layout 106. A media layout 106 may display multiple media element candidates to a user. The media layout 106 may show a text element 302, a digital image 304, an audio element 306, a video element 308, or other media element 310. The media layout 106 may also display an inert media element. An inert media element is a media element that is removed from the media element candidate pool, such as an advertisement 312. An inert media element may be identified by a disabling flag 314 embedded in the inert media element. Alternately, the media element may be automatically inert media type, such as a bitmap 316

Each of the media elements may be in a media state, such as an active media state 318, a chosen media state 320, a visible media state 322, and a present media state 324. An active media state 318 occurs in a sequential media element, such as a video element or an audio element, when that sequential media element is being played. A chosen media state 320 occurs in a media element when a user has selected that media element, possibly though highlighting with a cursor. Additionally, a chosen media state 320 may occur in a sequential media element when paused. A visible media state 322 occurs in a media element when the portion of the media layout 106 containing the media element is visible to the user. A present media state 324 occurs in a media element when the media element is in the media layout 106. The developer that created the media layout 106 may embed a developer hint 326 into the media element that the developer considers the primary focus of the media layout 106, but may be overridden. Alternately, the developer may embed a developer directive 328 that overrides any user selection.

The source media display application 104 may determine the media states of the media element candidates to implicitly select the selected media element 108. If the source media display application is going to share the selected media element, the implicit media selection may factor in the target media display platform. For a target media display platform capable of displaying a sequential media element, the source media display application 104 may first select a media element in an active media state 318, then a media element with a developer directive 328, then a media element in a chosen media state 320, then a media element in a visible media state 322, then a media element with a developer hint 326, and finally choosing a media element that is in a present media state 324. For a target media display platform incapable of displaying a sequential media element, the source media display application 104 may first select a media element with a developer directive 328, then a media element in a chosen media state 320, then a media element in a visible media state 322, then a media element with a developer hint 326, and finally choosing a media element that is in a present media state 324. Additionally, the type of target media display device may identify the selected media element 108. For example, if the target media display platform available is a digital audio receiver 118, and the media layout 106 has one audio media element 306, then that audio media element 306 may be implied to be the selected media element.

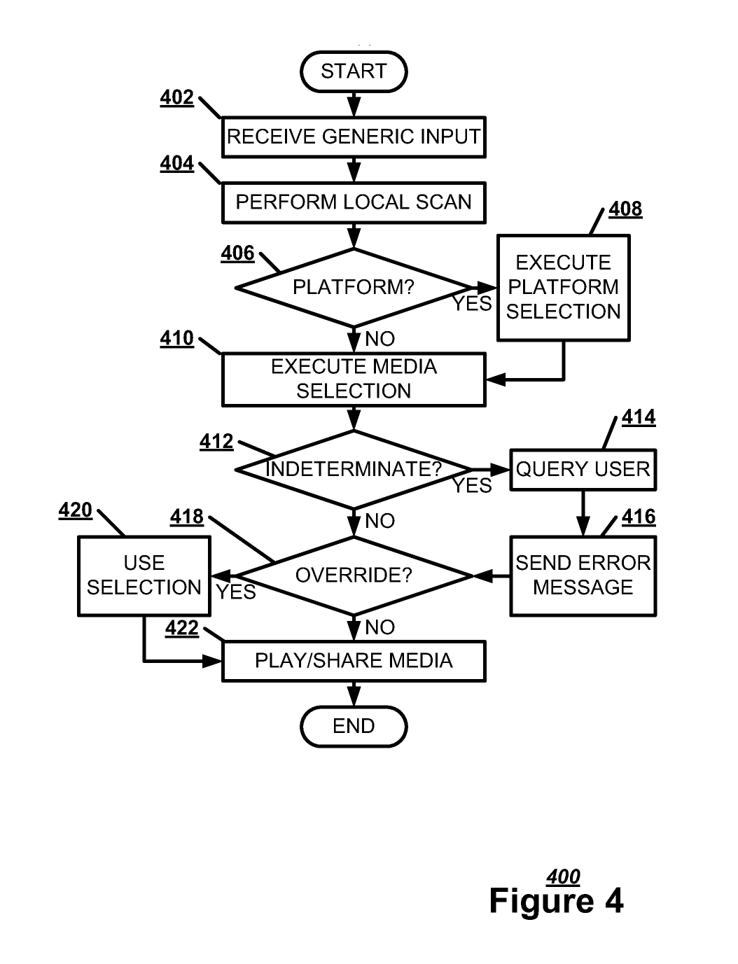

FIG. 4 illustrates, in a flowchart, one embodiment of a method 400 for sharing a selected media element 108. The media device 102 may receive a generic action input 110 from a user (Block 402). The media device 102 may perform a local area scan to identify a media display platform candidate (Block 404). If the media device 102 detects multiple media display platform candidates (Block 406), the media device 102 may execute an implicit platform selection of the target media display platform from multiple media display platform candidates to share the selected media element (Block 408). The media device 102 may execute an implicit media selection of a selected media element 108 from a multimedia layout 106 having multiple media element candidates displayed by a source media display application 104 (Block 410). The media device 102 may select at least one of a video element, an audio element, a digital image, a text element, or other media elements as the selected media element. If the implicit media selection or the implicit platform selection is indeterminate (Block 412), the media device 102 may query the user, such as through a pop-up dialogue box (Block 414). In addition or in the alternative, the media device 102 may display an error message to the user (Block 416). Otherwise, if the media device 102 receives a user override of the implicit media selection or the implicit platform selection (Block 418), the media device may use the media selection input or the platform selection input by the user (Bloc 420). The media device may perform an action on the selected media element 108 on the media display platform, such as playing or sharing the selected media element 108 with a target media display platform (Block 422).

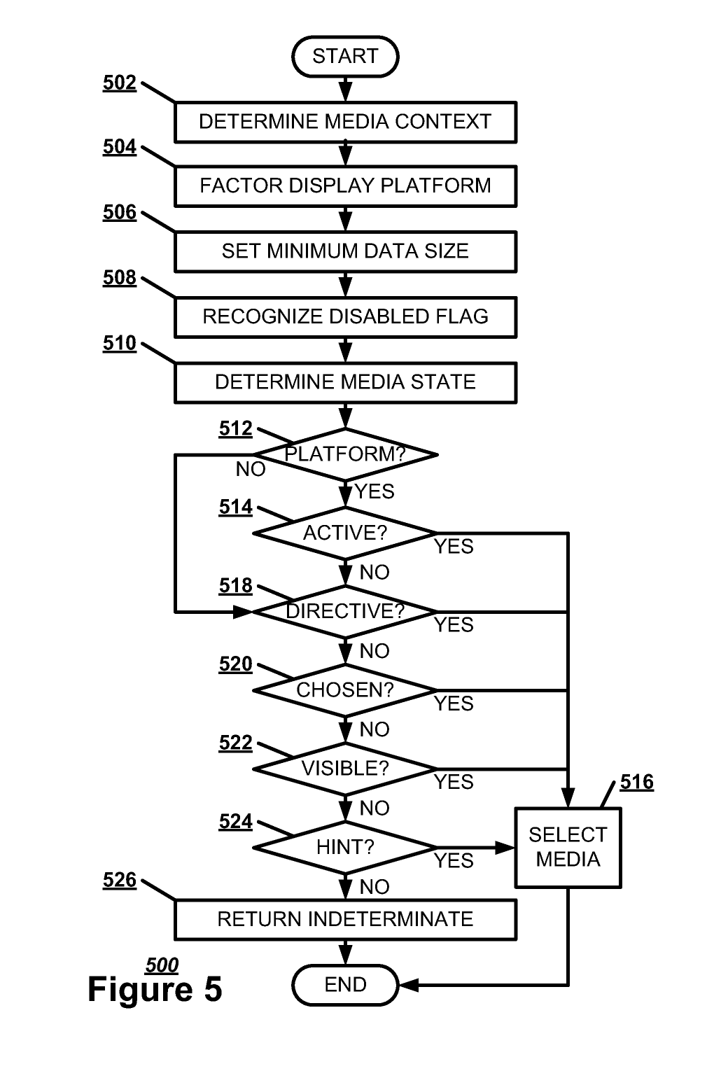

FIG. 5 illustrates, in a flowchart, one embodiment of a method 500 for executing an implicit media selection. The media device 102 may determine a media context to provide a media selection criterion for the implicit media selection (Block 502). The media context is based on the multiple media element candidates and the multiple media display platform candidates. The media device 102 may factor the target media display platform or the multiple media display platform candidates into the implicit media selection (Block 504). The media device 102 may set a minimum media element size to avoid the selection of bitmaps, icons, and other small images (Block 506). The media device 102 may recognize a disabling flag 314 in an inert media element from the multimedia layout 106, discounting the inert media element as a media element candidate (Block 508). The media device 102 may determine a media state of a media element candidate of the multiple media element candidates (Block 510). The media state may be one of an active media state, a chosen media state, a visible media state, a present media state, or other media state types.

The media device 102 may execute an implicit media selection of the selected media element from multiple media elements based on the media state of the selected media element. A display of the media device may display multiple media elements in a multimedia layout or on multiple media display applications. If a preliminary target media display platform is capable of displaying a sequential media element (Block 512), and a sequential media element is in an active media state 318 (Block 514), the media device 102 may select that media element as the selected media element 108 (Block 516). If a preliminary target media display platform is incapable of displaying a sequential media element (Block 512), and if a media device 102 identifies a developer directive in a media element candidate from the multimedia layout (Block 518), the media device 102 may select that media element as the selected media element 108 (Block 516). If a media element is in a chosen media state 320 (Block 520), the media device 102 may select that media element as the selected media element 108 (Block 516). If a media element is in a visible media state 322 (Block 522), the media device 102 may select that media element as the selected media element 108 (Block 516). If the media device 102 identifies a developer hint in a media element candidate from the multimedia layout (Block 524), the media device 102 may select that media element as the selected media element 108 (Block 516). The media device 102 may select at least one of a video element 308, an audio element 306, a digital image 304, a text element 302, or other media element 310 as the selected media element. Otherwise, the media device 102 may return an indeterminate result (Block 526). The media device 102 may rearrange the order of criteria based on the user preference and media context.

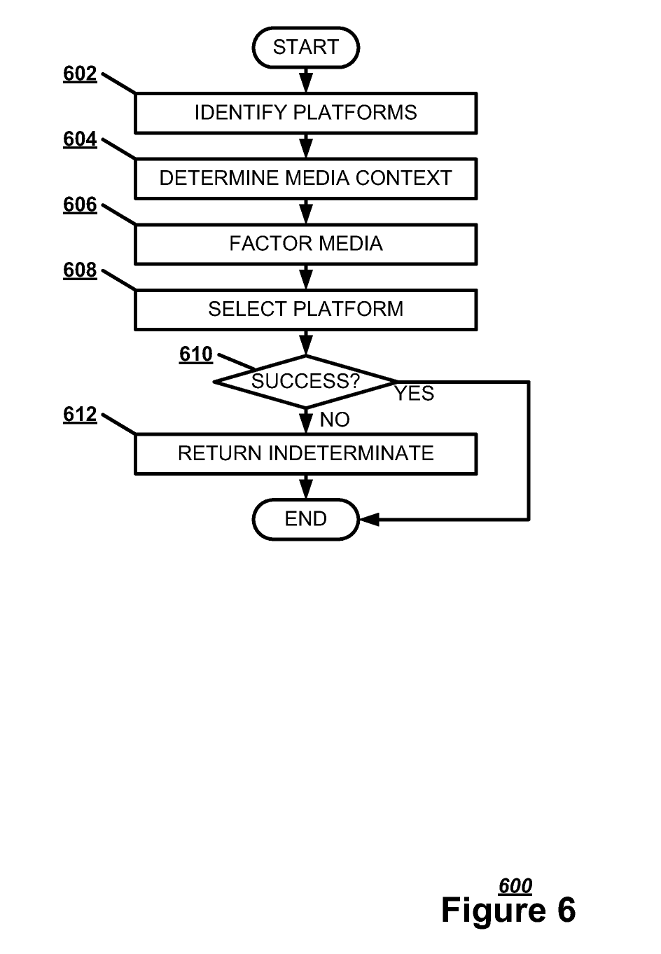

FIG. 6 illustrates, in a flowchart, one embodiment of a method 600 for executing an implicit platform selection. The media device 102 may identify the multiple media display platform candidates (Block 602). The media device 102 may determine a media context to provide a platform selection criterion for the implicit platform selection (Block 604). The media context is based on the multiple media element candidates and the multiple media display platform candidates. The media device 102 may factor the selected media element 108 or the multiple media element candidates into the implicit platform selection (Block 606). The media device may select either a target media display application or a target media display device as the target media display platform (Block 608). If the implicit platform selection is unsuccessful (Block 610), the media device 102 may return an indeterminate result (Block 612).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include non-transitory computer-readable storage media for carrying or having computer-executable instructions or data structures stored thereon. Such non-transitory computer-readable storage media may be any available media that can be accessed by a general purpose or special purpose computer. By way of example, and not limitation, such non-transitory computer-readable storage media can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
receiving a generic action input from a user;
executing an implicit media selection of a selected media element from a multimedia layout having multiple media element candidates displayed by a source media display application.

2. The method of claim 1, further comprising:
executing an implicit platform selection of a target media display platform from multiple media display platform candidates to share the selected media element.

3. The method of claim 2, further comprising:
factoring the target media display platform into the implicit media selection.

4. The method of claim 1, further comprising:
determining a media state of a media element candidate of the multiple media element candidates.

5. The method of claim 4, further comprising:
determining if the media state is at least one of an active media state, a chosen media state, a visible media state, and a present media state.

6. The method of claim 1, further comprising:
setting a minimum media element size.

7. The method of claim 1, further comprising:
determine a media context to provide a media selection criterion for the implicit media selection.

8. The method of claim 1, further comprising:
identifying a developer hint from the multimedia layout.

9. The method of claim 1, further comprising:
recognizing a disabling flag in an inert media element from the multimedia layout.

10. The method of claim 1, further comprising:
receiving a user override of the implicit media selection.

11. The method of claim 1, further comprising:
querying the user if the implicit media selection is indeterminate.

12. The method of claim 1, further comprising:
displaying an error message to the user if the implicit media selection is indeterminate.

13. The method of claim 1, further comprising:
selecting at least one of a video element, an audio element, a digital image, and a text element as the selected media element.

14. A tangible machine-readable medium having a set of instructions detailing a method stored thereon that when executed by one or more processors cause the one or more processors to perform the method, the method comprising:
receiving a generic action input from a user;
executing an implicit platform selection of a target media display platform from multiple media display platform candidates; and
sharing a selected media element from a multimedia layout having multiple media element candidates displayed by a source media display application with a target media display platform.

15. The tangible machine-readable medium of claim 14, wherein the method further comprises:
executing an implicit media selection of the selected media element from the multiple media element candidates.

16. The tangible machine-readable medium of claim 14, wherein the method further comprises:
factoring the selected media element into the implicit platform selection.

17. The tangible machine-readable medium of claim 14, wherein the method further comprises:
querying the user if the implicit platform selection is indeterminate.

18. The tangible machine-readable medium of claim 14, wherein the method further comprises:
selecting at least one of a target media display application and a target media display device as the target media display platform.

19. A media device, comprising:
a user input that receives a generic action input from a user;
a display may display multiple media elements;
a processor that executes an implicit media selection of a selected media element from the multiple media elements based on a media state of the selected media element and executes an implicit platform selection of the target media display platform from multiple media display platforms; and
a communication interface that shares the selected media element with the target media display platform.

20. The media device of claim 19, wherein the communication interface performs a local area scan to detect the multiple media display platforms.
